(19) United States
(12) Patent Application Publication
(10) Pub. No.: US 2025/0150953 A1
(43) Pub. Date: May 8, 2025

(54) METHOD AND SYSTEM FOR MANAGING TEMPORARY SLICE DEPLOYMENT IN 3GPP

(71) Applicant: Samsung Electronics Co., Ltd., Suwon-si, Gyeonggi-do (KR)

(72) Inventor: Ashok Kumar NAYAK, Bangalore (IN)

(21) Appl. No.: 18/835,214

(22) PCT Filed: Feb. 2, 2023
(86) PCT No.: PCT/KR2023/001542

§ 371 Date: Aug. 1, 2024

(30) Foreign Application Priority Data
Feb. 3, 2022 (IN) 202241005898
Jan. 10, 2023 (IN) 2022 41005898

(51) Int. Cl. H04W 48/18; H04W 48/02; H04W 48/16

(52) U.S. Cl. CPC H04W 48/18; H04W 48/02; H04W 48/16

(57) ABSTRACT

Methods and system for managing temporary slice deployment in 3GPP. Embodiments herein disclose systems and methods for managing temporary slice deployment in 3GPP. The operator or slice owner can commission the Network Functions (NFs) with validity criteria of temporary network slices. On expiry of the validity criteria, the NFs will decommission the temporary network slice. When the UE requests for these temporary network slices, the Access and Mobility Management Function (AMF) provides the UE with the temporary network slices along with its validity criteria. Before expiry of the validity criteria, the UE releases an ongoing protocol data unit (PDU) session, and then removes the network slice on expiry of the validity criteria. The UE will only be able to access services from the temporary network slice if the UE is located in the temporary network slice's service area.

### CROSS-REFERENCE TO RELATED APPLICATION(S)

This application is a U.S. National Stage application under 35 U.S.C. § 371 of an International application number PCT/KR2023/001542, filed on Feb. 2, 2023, which is based on and claims priority of an Indian Provisional patent application number 202241005898, filed on Feb. 3, 2022, in the Indian Intellectual Property Office, and of an Indian Non-Provisional patent application No. 202241005898, filed on Jan. 10, 2023, in the Indian Intellectual Property Office, the disclosure of each of which is incorporated by reference herein in its entirety.

### TECHNICAL FIELD

Embodiments disclosed herein relate to network slicing in 3GPP (third generation partnership project) and more particularly to systems and methods for management of temporary slices that are deployed in 3GPP networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

When operators deploy one slice (including slice instances) in the network, it will follow the procedures, information and configuration as described in TS 23.501, TS 23.502, TS 23.503. Examples are, but not limited to, Access Network (AN) selection and AMF (Access and Mobility Management Function) selection with help of NSSF (Network Slice Selection Function) during registration, SMF (Session Management Function), PCF (Policy Control Function), UPF (User Plane Function) selection during PDU (Protocol Data Unit) session establishment, NRF (Network Repository Function) registration & discovery for the supported slices, NSSRG (Network Slice Simultaneous Registration Group) configuration, URSP (User Equipment Route Selection Policy) configuration, Configured S-NSSAIs, and so on.

These configurations and procedures are executed before the UE really gets the required services for the specific slices. These slices can be permanently or temporarily deployed by the operator.

The slices are differentiated to provide a specific type of service and hence the operator or slice owner may deploy various kind of slices in the system to cater to various requirements of the end user or applications. Generally, these slices are deployed permanently in the system.

But when a particular event occurs (such as the Olympics, FIFA World Cup, etc), the operator may deploy a slice for providing exclusive services that are related to the particular event, and once this event has run its course, the operator may terminate the slice. A drawback with these kind of temporary deployment of slices is that when the operator terminates these slices, there will be lot of configurations in the NFs, where it was initially configured during the deployment. Also, there will be lot of control plane signalling messages needed to update all those UEs that were using these slices.

Also, during the deployment of temporary slices, the operator or the slice owner may need to configure subscribed slices in the UE's subscription profile in UDM (Unified Data Management) and provide the subscribed slices to the AMF & SMF during registration and PDU session establishment. During termination of the temporary slices, the UDM needs to send updated subscribed S-NSSAIs to the AMF & SMF. The AMF, in turn, has to update the UE with the updated allowed NSSAI, which in turn increases the control plane signalling.

Also, it may happen that these temporary slices are deployed in locations that do not match with the existing tracking areas (TA). So, it will be difficult for the network to assign the list of tracking areas as part of the registration area. When provided, the allowed NSSAI may include this temporary slice to the UE. It is therefore desirable to implement systems and methods that overcome the drawbacks associated with these temporary network slices that are deployed.

### Solution to Problem

Accordingly, the embodiments herein provide systems and methods for managing temporary network slices such that 3GPP is able to enhance the procedure which reduces the configuration and control plane messages in the network.

Embodiments herein disclose a method for managing network slice involvement, which comprises determining, by an operator, a requirement to deploy the network slice for a limited duration; and commissioning, by the operator, at least one Network Function (NF), that supports the network slice, with a validity criteria, wherein the validity criteria indicates at least one of a duration or a location for which the network slice is capable of offering one or more services. The first method further comprises decommissioning, by the at least one NF, the network slice from its configuration on expiry of the validity criteria, wherein the removal happens implicitly without any exchange of messages. The first method further comprises receiving, by an AMF, from a User Equipment (UE), a registration message including a Requested Network Slice Selection Assistance Information (NSSAI); determining, by the AMF, if the Requested NSSAI contains at least one slice that meets the validity criteria of a limited duration network slice; and sending, by the AMF, the network slice, including its validity criteria, if the Requested NSSAI contains at least one slice meeting the validity criteria. The first method further comprises receiving, by the UE, the network slice along with its validity criteria in at least one of the following: the Configured NSSAI, the Allowed NSSAI, the Rejected NSSAI, the Pending NSSAI, and the UE route selection policy (URSP); and establishing, by the UE, a protocol data unit (PDU) session using the received network slice matching the validity criteria. The first method further comprises removing, by the UE, the network slice from at least one of the following: the Configured NSSAI, the Allowed NSSAI, the Rejected NSSAI, the Pending NSSAI, and the UE route selection policy (URSP), on the expiry of the duration if the validity criteria of the network slice indicates the duration for which the network slice is capable of offering the one or more services.

Embodiments herein disclose a method for managing network slice involvement, which comprises determining by an operator, a requirement to deploy a temporary network slice for a service area; and creating, by the operator, the slice service area including at least one type of Network Function (NF), wherein the at least one type of NF allows a User Equipment (UE) to access the network slice based on an identifier of the UE, wherein the identifier is configured in the at least one type of NF (30), and wherein the UE can access the services offered by the network slice if the UE is present in the slice service area. The second method further comprises receiving, by the UE, from an Access and Mobility Management Function (AMF) in at least one of the following: a Configured Network Slice Selection Assistance Information (NSSAI), an Allowed NSSAI, a rejected NSSAI, a pending NSSAI, and a UE route selection policy (URSP): a tracking area identity (TAI) list that comprises the slice service area of the network slice, and the network slice with a validity timer that indicates the duration of validity of the network slice. The second method further comprises releasing, by the UE, an ongoing protocol data unit (PDU) session before expiry of the validity timer by sending a PDU session release message; and removing, by the UE, the network slice from at least one of the Configured Network Slice Selection Assistance Information (NSSAI), the Allowed NSSAI, the rejected NSSAI, the pending NSSAI, and the UE route selection policy (URSP) on expiry of the validity timer.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The present disclosure provides systems and methods for ensuring that 3GPP is able to enhance the procedure which reduces the configuration and control plane messages in the network in case of temporary slice deployment.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a system for managing deployment of temporary network slices, according to embodiments as disclosed herein;

FIG. 2 illustrates a method for managing deployment of temporary network slices, according to embodiments as disclosed herein; and

FIG. 3 illustrates a method for managing deployment of temporary network slices over a slice service area, according to embodiments as disclosed herein.

FIG. 4 illustrates an exemplary diagram of a network function (NF), according to an embodiment of the present disclosure; and

FIG. 5 illustrates a diagram of the configuration of a user equipment (UE) in a wireless communication system, according to an embodiment of the present disclosure.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve systems and methods for ensuring that 3GPP is able to enhance the procedure which reduces the configuration and control plane messages in the network in case of temporary slice deployment. A network operator can determine if a network slice is to be deployed temporary (based on a requirement), and accordingly may configure a network function (NF) that supports the network slice with a validity criteria of the network slice. The validity criteria indicates the ability of the network slice to offer one or more services based on the criteria. For example, the validity criteria can include a duration for which the network slice is capable of offering the one or more services, or the validity criteria can include a location within which the network slice is capable of offering the one or more services. On expiry of the validity criteria, the NF may decommission the network slice from its configuration, and this process can happen implicitly where no exchange of messages takes place; thereby, the embodiments herein are able to overcome the previous drawback of excessive control plane signalling messages.

On the UE requesting this temporary network slice and receiving the temporary network slice, the UE may also receive the validity criteria of the temporary network slice with the temporary network slice. On expiry of the validity criteria (e.g., duration), the UE may remove the network slice from one of the Configured Network Slice Selection Assistance Information (NSSAI), Allowed NSSAI, Rejected NSSAI, Pending NSSAI, and UE route selection policy (URSP).

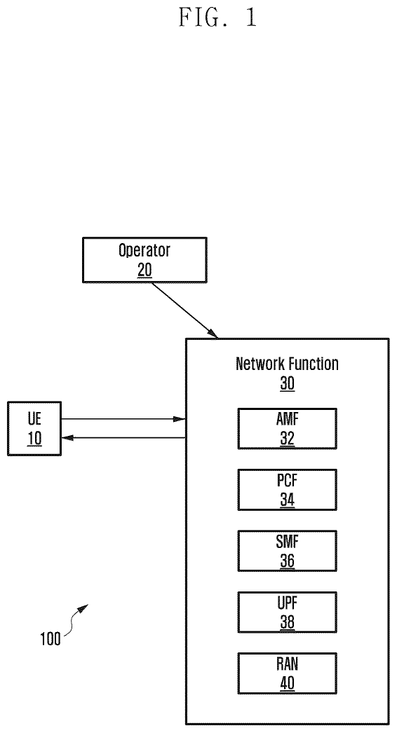

Referring now to the drawings, and more particularly to FIGS. 1 through 3, where similar reference characters denote corresponding features consistently throughout the figures, there are shown at least one embodiment.

The system 100 comprises the operator 20, the UE 10, and the NF 30. The operator 20 may determine if a network slice is to be deployed for a limited duration (i.e., a temporary network slice). This determination may be based on a requirement; once this happens, the operator 20 may commission at least one NF 30, that supports the network slice, with a validity criteria. The requirement can be a scenario, where the network foresees an increase in network traffic for a specific and limited duration in one or more specific areas. Examples of the requirements can be, but not limited to, Olympics, FIFA World Cup, Super Bowl, Cricket World Cup, and so on. The validity criteria may be a measure for the validity of the network slice, i.e., the capability of the network slice to offer one or more services. The validity criteria can be based on a duration of the network slice or a location in which the network slice is deployed and can be defined by a network operator. The duration of the network slice can be timer-based, i.e., a specific time allotted to the network slice, such as 12 hours, 96 hours etc.

As the at least one NF 30 is configured with the validity criteria of the network slice, it can determine when the network slice is set to expire. On expiry of the validity criteria, which may lead to the expiry of the network slice, the at least one NF 30 may decommission the network slice. This process can lead to the implicit removal of the network slice, where no control plane messages are required to be exchanged. Examples of the at least one NF 30 can include the AMF 32, a PCF (Policy Control Function) 34, a SMF (Session Management Function) 36, a UPF (User Plane Function) 38, and a Radio Access Network (RAN) node 40. Embodiments herein have been explained using the AMF 32, as an example of the NF 30; however, it may be obvious to a person of ordinary skill in the art that embodiments herein may be implemented on any other NF 30, such as, but not limited to, the PCF 34, the SMF 36, the UPF 38, and the RAN node 40.

The UE 10 may be configured to send to the AMF 32 a registration message that includes a Requested NSSAI. The AMF 32 may determine if the Requested NSSAI contains a network slice that meets the validity criteria for a temporary network slice. If the network slice meets this validity criteria, the AMF 32 may send to the UE 10 the network slice along with its validity criteria. The validity criteria can be sent to the UE 10 as part of Configured NSSAI, Rejected NSSAI, Pending NSSAI, and URSP, and the UE 10 may also receive it in the same manner.

Once the UE 10 has received the temporary network slice, the UE 10 may establish a protocol data unit (PDU) session. As the UE 10 has received the validity criteria of the temporary network slice, the UE 10 may remove the network slice from one of the following: Configured NSSAI, Rejected NSSAI, Pending NSSAI, and UE route selection policy on expiry of the validity criteria (e.g., duration) of the temporary network slice. Before expiry of the validity criteria, the UE 10 may release the ongoing PDU session by sending out a PDU session release message; this can allow for a graceful termination. On expiry of the validity criteria, the UE 10 may remove the network slice from one of the Configured NSSAI, Allowed NSSAI, Rejected NSSAI, Pending NSSAI, and URSP.

If the network slice, received by the UE 10 does not match with the validity criteria (e.g. location) provided by the AMF 32, the UE 10 may not establish a PDU session.

In some embodiments, the validity criteria can be received by the UE 10, from the AMF 32, as a tracking area identity (TAI) list or a validity timer. The TAI list can comprise a slice service area of the temporary network slice, i.e., an area in which the at least one NF 30 is present. As the temporary slice is intended for a specific location (slice service area), the operator 20 may configure the slices only in the NFs 30 that cover the slice service area instead of all the NFs in the entire PLMN (public land mobile network). For seamless UE movement to get the services for this temporary slice, all these NFs part of the location will be able to provide the service as only these NFs support temporary slice. The at least one NF 30 can allow the UE 10 to access the network slice based on an identifier of the UE 10, wherein the identifier of the UE is configured in the at least one type of NF, i.e. only UEs 10 that have subscribed to the temporary network slice service would be allowed to access the temporary network slice.

In addition to this, the UE 10 may only be allowed to access the temporary network slice if it is present in the slice service area of the temporary network slice. For example, for a sporting event, the UE 10 may be allowed to access the exclusive services relating to the sporting event only if the UE 10 is subscribed to those exclusive services and also if the UE 10 is located in an area in which the sporting event is being held. If the UE 10 is not located in the slice service that is within the TAI list, the UE may not use the network slice to create a PDU session.

Before expiry of the validity timer, the UE may release an ongoing PDU session by sending a PDU session release message. On expiry of the validity timer, the UE may remove the network slice from one of Configured NSSAI, Allowed NSSAI, Rejected NSSAI, Pending NSSAI, and URSP.

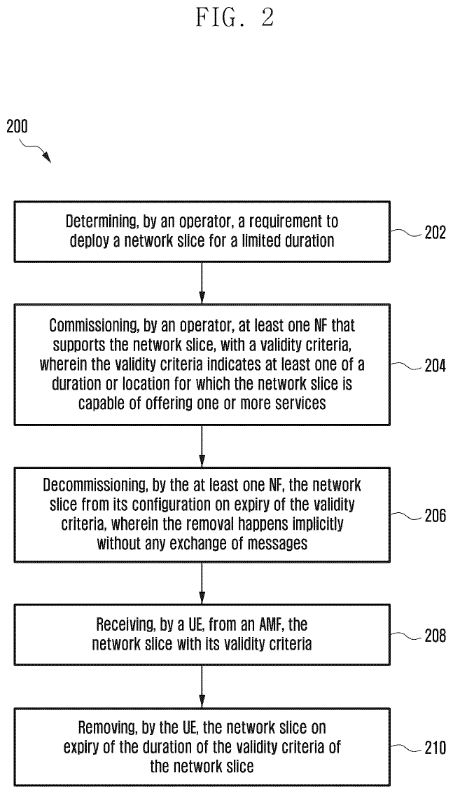

FIG. 2 illustrates a method 200 for managing temporary network slice deployment, according to embodiments as disclosed herein. At step 202, the operator 20 may determine if the network slice is to be deployed for a limited duration (i.e., temporary network slice), based on a requirement. At step 204, the operator 20 may commission at least one NF 30, that supports the network slice, with a validity criteria, wherein the validity criteria indicates at least one of a duration or location for which the network slice is capable of offering one or more services. At step 206, the at least one NF 30 may decommission the network slice from its configuration on expiry of the validity criteria, wherein the removal happens implicitly without any exchange of messages. At step 208, the UE 10 may receive from an AMF 32, the network slice with its validity criteria. The UE 10 may receive this network slice in response to the AMF 32 receiving from the UE 10 a Requested NSSAI that included the network slice. At step 210, the UE 10 may remove the network slice on expiry of the duration of the validity criteria of the network slice. The UE 10 may remove the network slice from at least one of: Configured NSSAI, Allowed NSSAI, Pending NSSAI, Rejected NSSAI, and URSP. The UE 10 may also release an ongoing PDU session before expiry of the validity criteria by sending a PDU release message. The various actions in the flow process 200 may be performed in the order presented, in a different order or simultaneously. Further, in some embodiments, some actions listed in FIG. 2 may be omitted.

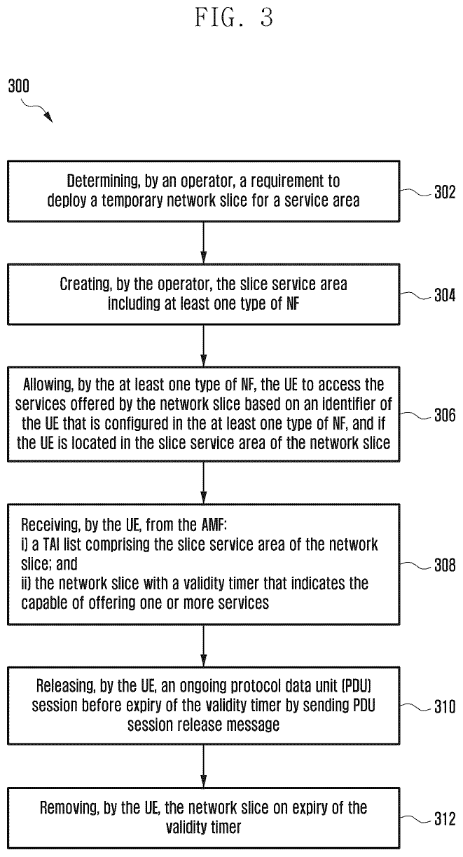

FIG. 3 illustrates a method for managing temporary network slice deployment over a slice service area, according to embodiments as disclosed herein. At step 302, the operator 20 may determine a requirement to deploy the temporary network slice for a service area. At step 304, the operator 20 may create the slice service area, wherein the slice service area includes at least one type of NF 30 (e.g., AMF 32, SMF etc.). At step 306, the at least one type of NF 30 may allow the UE 10 to access the services offered by the temporary network slice based on an identifier of the UE 10 that is configured in the at least one type of NF 30, and if the UE 10 is located in the slice service area of the temporary network slice. At step 308, the UE 10 may receive from the AMF 32:
a. a TAI list comprising the slice service area of the temporary network slice; and
b. the network slice with a validity timer that indicates the duration of the validity of the network slice (i.e. capability of the network slice to offer one or more services).

At step 310, the UE 10 may release an ongoing PDU session before expiry of the validity timer by sending a PDU session release message. At step 312, the UE 10 may remove the network slice on expiry of the validity timer. The various actions in method and 300 may be performed in the order presented, in a different order or simultaneously. Further, in some embodiments, some actions listed in FIG. 3 may be omitted.

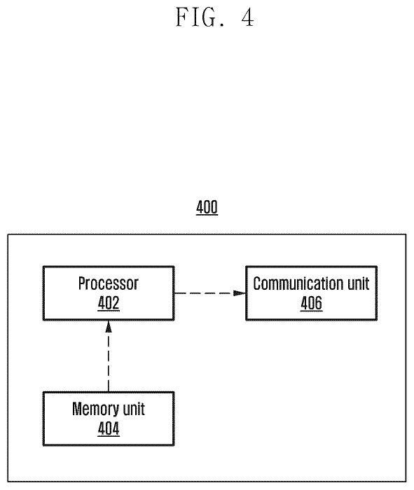

FIG. 4 illustrates an exemplary diagram of a network function (NF), according to an embodiment of the present disclosure. The NF 400 may include at least one processor 402, a memory unit 404 (e.g., storage), and a communication unit 406 (e.g., communicator or communication interface). Further, the NF 400 may also include the Cloud-RAN (C-RAN), a Central Unit (CU), a core Network (NW), a Distributed unit (DU) or the any other possible network (NW) entity. The communication unit 406 may perform one or more functions for transmitting and receiving signals via a wireless channel.

As an example, the processor 402 may be a single processing unit or a number of units, all of which could include multiple computing units. The processor 402 may be implemented as one or more microprocessors, microcomputers, microcontrollers, digital signal processors, central processing units, state machines, logic circuitries, and/or any devices that manipulate signals based on operational instructions. Among other capabilities, the processor 402 is configured to fetch and execute computer-readable instructions and data stored in the memory. The processor 402 may include one or a plurality of processors. At this time, one or a plurality of processors 402 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 402 may control the processing of the input data in accordance with a predefined operating rule or artificial intelligence (AI) model stored in the non-volatile memory and the volatile memory, i.e., memory unit 404. The predefined operating rule or artificial intelligence model is provided through training or learning.

The memory 404 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

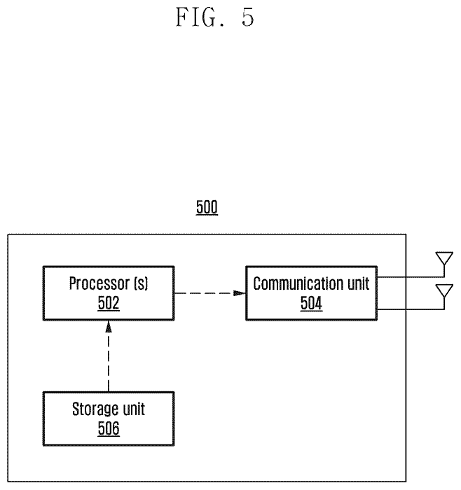

FIG. 5 is a diagram illustrating the configuration of a user equipment (UE) in a wireless communication system, according to an embodiment of the present disclosure. The configuration of FIG. 5 may be understood as a part of the configuration of the UE 500. Hereinafter, it is understood that terms including “unit” or “module” at the end may refer to the unit for processing at least one function or operation and may be implemented in hardware, software, or a combination of hardware and software.

Referring to FIG. 5, the UE 500 may include at least one processor 502, a communication unit 504 (e.g., communicator or communication interface), and a storage unit 506 (e.g., storage). By way of example, the UE 500 may be a User Equipment, such as a cellular phone or other device that communicates over a plurality of cellular networks (such as a 3G, 4G, a 5G or pre-5G, 6G network or any future wireless communication network). The communication unit 504 may perform functions for transmitting and receiving signals via a wireless channel.

As an example, the processor 502 may be a single processing unit or a number of units, all of which could include multiple computing units. The processor 502 may be implemented as one or more microprocessors, microcomputers, microcontrollers, digital signal processors, central processing units, state machines, logic circuitries, and/or any devices that manipulate signals based on operational instructions. Among other capabilities, the processor 502 is configured to fetch and execute computer-readable instructions and data stored in the memory. The processor 502 may include one or a plurality of processors. At this time, one or a plurality of processors 502 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 502 may control the processing of the input data in accordance with a predefined operating rule or artificial intelligence (AI) model stored in the non-volatile memory and the volatile memory, i.e., memory unit 504. The predefined operating rule or artificial intelligence model is provided through training or learning.

The memory 504 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

Some example embodiments disclosed herein may be implemented using processing circuitry. For example, some example embodiments disclosed herein may be implemented using at least one software program running on at least one hardware device and performing network management functions to control the elements.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1.-15. (canceled)

16. A method performed by a terminal in a communication system, the method comprising:
receiving, from an access and mobility management function (AMF), a message including configured network slice selection assistance information (NSSAI) including a single network slice selection assistance information (S-NSSAI), wherein a validity time is configured for the S-NSSAI based on the message:
identifying whether the validity time for the S-NSSAI expires based on the message; and
in case that the validity time for the S-NSSAI expires, removing the S-NSSAI from the configured NSSAI, based on an expiry of the validity time for the S-NSSAI.

17. The method of claim 16,
wherein the validity time indicates whether a network slice associated with the S-NSSAI is available for a limited time duration, and is determined based on a configuration of operation, administration, and maintenance (OAM), and
wherein the S-NSSAI is removed from the configured NSSAI without receiving any signal from the AMF.

18. The method of claim 16, further comprising:
performing an establishment procedure for a protocol data unit (PDU) session associated with the S-NSSAI, in case that the validate time for the S-NSSAI does not expire.

19. The method of claim 16,
wherein the message further includes allowed NSSAI, including the S-NSSAI, and
wherein the S-NSSAI is removed from the allowed NSSAI, based on the expiry of the validity time for S-NSSAI.

20. A method performed by an access and mobility management function (AMF) in a communication system, the method comprising:
identifying configured network slice selection assistance information (NSSAI) for a terminal, the configured NSSAI including a single network slice selection assistance information (S-NSSAI); and
transmitting, to the terminal, a message including the configured NSSAI,
wherein a validity time is configured for the S-NSSAI based on the message, and
wherein in case that the validity time for the S-NSSAI expires, the S-NSSAI is removed from the configured NSSAI in the terminal.

21. The method of claim 20,
wherein the validity time indicates whether a network slice associated with the S-NSSAI is available for a limited time duration, and is determined based on a configuration of operation, administration, and maintenance (OAM), and
wherein the S-NSSAI is removed from allowed NSSAI without transmitting any signal to the terminal.

22. The method of claim 20, wherein, in case that the validate time for the S-NSSAI does not expire, an establishment procedure for a protocol data unit (PDU) session associated with the S-NSSAI is performed by the terminal.

23. The method of claim 20, further comprising:
removing the S-NSSAI from allowed NSSAI for the terminal, in case that the validity time expires.

24. A terminal in a communication system, the terminal comprising:
a transceiver; and
a processor coupled with the transceiver and configured to:
receive, from an access and mobility management function (AMF), a message including configured network slice selection assistance information (NSSAI) including a single network slice selection assistance information (S-NSSAI), wherein a validity time is configured for the S-NSSAI based on the message,
identify whether the validity time for the S-NSSAI expires based on the message, and
in case that the validity time for the S-NSSAI expires, remove the S-NSSAI from the configured NSSAI, based on an expiry of the validity time for the S-NSSAI.

25. The terminal of claim 24,
wherein the validity time indicates whether a network slice associated with the S-NSSAI is available for a limited time duration, and is determined based on a configuration of operation, administration, and maintenance (OAM), and
wherein the S-NSSAI is removed from the configured NSSAI without receiving any signal from the AMF.

26. The terminal of claim 24, wherein the processor is further configured to perform an establishment procedure for a protocol data unit (PDU) session associated with the S-NSSAI, in case that the validate time for the S-NSSAI does not expire.

27. The terminal of claim 24,
wherein the message further includes allowed NSSAI, including the S-NSSAI, and
wherein the S-NSSAI is removed from the allowed NSSAI, based on the expiry of the validity time for S-NSSAI.

28. An access and mobility management function (AMF) in a communication system, the AMF comprising:
a transceiver; and
a processor coupled with the transceiver and configured to:
identify configured network slice selection assistance information (NSSAI) for a terminal, the configured NSSAI including a single network slice selection assistance information (S-NSSAI), and
transmit, to the terminal, a message including the configured NSSAI, wherein a validity time is configured for the S-NSSAI based on the message, and
wherein in case that the validity time for the S-NSSAI expires, the S-NSSAI is removed from the configured NSSAI in the terminal.

29. The AMF of claim 28,
wherein the validity time indicates whether a network slice associated with the S-NSSAI is available for a limited time duration, and is determined based on a configuration of operation, administration, and maintenance (OAM),
wherein the S-NSSAI is removed from the configured NSSAI without transmitting any signal to the terminal, and
wherein the case that the validate time for the S-NSSAI does not expire, a protocol data unit (PDU) session associated with the S-NSSAI is established.

30. The AMF of claim 28, wherein the processor is further configured to remove the S-NSSAI from allowed NSSAI for the terminal, in case that the validity time expires.
